(19) United States
(12) Patent Application Publication
(10) Pub. No.: US 2026/0078812 A1
(43) Pub. Date: Mar. 19, 2026

(54) COMPONENT FOR ABSORBING ENERGY AND A PROCESS FOR PRODUCING THE COMPONENT

(71) Applicant: BASF SE, Ludwigshafen am Rhein (DE)

(72) Inventors: Andreas WÜST, Ludwigshafen am Rhein (DE); Torsten HENSEL, Ludwigshafen am Rhein (DE)

(21) Appl. No.: 19/110,520

(22) PCT Filed: Sep. 14, 2023
(86) PCT No.: PCT/EP2023/075265

§ 371 Date: Mar. 11, 2025

(30) Foreign Application Priority Data
Sep. 14, 2022 (EP) 22195698.0

(51) Int. Cl. F16F 7/12

(52) U.S. Cl. CPC F16F 7/12; F16F 2224/0208; F16F 2224/0225; F16F 2224/0233; F16F 2226/04; F16F 2228/007

(57) ABSTRACT

The invention relates to a component for absorbing energy of an impact applied to the component (19), wherein the component (19) is plastically deformable by an impact and optionally can undergo at least some extent of destruction, the component (19) comprising a sheet profile (1) as a main component and a foamed secondary component (17), wherein the foamed secondary component (17) is connected to the sheet profile (1) and has a density of more than 0.2 g/cm3. The invention further relates to a composite unit (21) built from such components (17) and a process for producing the component (17).

The invention relates to a component for absorbing energy from an impact applied to the component, the component comprising a sheet profile and a foamed secondary component.

Components for absorbing energy from an impact to which the component has been subjected, via deformation, are used for example in automobile construction. Such components may be for example bumpers, assembly parts arranged between the transverse bumper member and the bumper of a vehicle, or A-, B-, or C-pillars of the car body as well as in the rocker area.

Structures for absorbing energy, which are also termed as crash absorbers, for example are produced from molded foams based on polypropylene or on polyurethanes. A characteristic feature of the materials of these systems is their low modulus of elasticity for static pressure load or dynamic impact load, with resulting large deformation distances.

Besides such crash absorbers made of polymer foams, also crash absorbers made of metal structures or polymer structures are known. The design of these generally involves ribs or a honeycomb structure. However, a disadvantage of these crash absorbers is that they are usually subject to sudden failure rather than inhibiting uniform deformation when subjected to a force, for example caused by an impact.

Also sheet profiles as usually used for A-, B-, or C-pillars of a vehicle have the disadvantage of a sudden drop in the force level when subjected to a force, wherein these sheet profiles generally bend.

For optimizing the force/displacement curve, it is known from EP-A 2 404 788 to provide a component for absorbing energy which comprises a core made of a polymer foam with a density of at most 0.2 g/cm³.

A further component for absorbing energy is disclosed in WO-A 2017/137480, the component comprising a main structure and a secondary structure. The main structure is made from a metal or a continuous-fiber reinforced polymer material and the secondary structure is made from an unreinforced polymer material or a polymer material which is reinforced with short fibers or long fibers.

If crash absorbers are to absorb a large amount of energy, the sheet profile must have a design, which allows for absorbing the desired energy and which does not completely fail before the desired amount of energy is absorbed. This may result in complex designs of the sheet profile or in undesired thickness of the sheet used for the sheet profile.

Therefore, it is an object of the present invention to provide a component for absorbing energy of an impact applied to the component, which has a less complex design and/or has a lower weight than known crash absorbers for absorbing the same amount of energy.

This object is achieved by a component for absorbing energy of an impact applied to the component, wherein the component is plastically deformable by an impact and optionally can undergo at least some extent of destruction, the component comprising a sheet profile as main component and a foamed secondary component, wherein the foamed secondary component is connected to the sheet profile and has a density of more than 0.2 g/cm³.

By connecting the foamed secondary component to the sheet profile the kind of energy absorption of a foam and the kind of energy absorption of a sheet profile is combined. Usually, if a metal is used as material for the sheet profile, the sheet profile absorbs energy by controlled bending of the profile. If a polymer is used as material for the sheet profile, the energy is absorbed by controlled destruction of the material, for example by tearing or breaking of fibers used for reinforcing the polymer or by tearing or breaking of the compound, if the polymer is not reinforced or long fibers or short fibers are used for reinforcing.

A foamed secondary component usually absorbs energy by elastic deformation. However, this allows only for comparably small amounts of energy which can be absorbed by a foam.

In the inventive component, the energy absorption types of a sheet profile and a foamed secondary component are combined. By this combination, it is possible to design the sheet profile less complex and/or to use a sheet material having a smaller thickness compared to a sheet profile having the same absorption characteristics without combining it with a foamed secondary component.

Upon impact on the component, the sheet profile as main component absorbs the main part of the energy. Due to the energy absorption, the sheet profile deforms in a controlled manner. By the foamed secondary component, the amount of energy which can be absorbed by the main component can be increased because the foamed component assures the correct deformation by supporting it. For this reason, the component comprising the sheet profile and the foamed secondary component can absorb a larger amount of energy than the sheet component without the foamed secondary component.

The material, the sheet profile is made of can be any suitable material which can be deformed or destroyed in a controlled manner upon impact on the component. Preferably, the sheet profile is made of a metal or a polymer.

If the sheet profile is made of a metal, any metal which deforms elastically or plastically upon impact can be used, with steel, aluminum or an aluminum comprising alloy being preferred.

If the sheet profile is made of a polymer, it is preferred, if the sheet profile is made of a polyamide (PA), polybutylene terephthalate (PBT), polystyrene (PS) or polypropylene (PP) or polyethylene (PE). Independently of the type of polymer used for sheet profile, the polymer can be reinforced or unreinforced, with reinforced polymers being preferred.

For reinforcing the polymer, preferably fibers are used. Suitable fibers for reinforcing the polymer may be for example short fibers, long fibers, continuous fibers or mixtures of at least two of these. The fibers may be for example carbon fibers, glass fiber, aramid fibers or mineral fibers. If continuous fibers are used for reinforcing, the fibers may be used for example as woven fabric, knitted fabric or in the form of rovings. Further, continuous fibers may be arranged in parallel or in layers, wherein the fibers of each layer are arranged in parallel and the fibers of two adjacent layers enclose any angle in the range from 10 to 90°.

The polymer may contain further additives for setting the properties. Such additives are for example dyes, plasticizers, stabilizers like UV-stabilizers, flame retardants and any other additives known to the skilled person.

The foamed secondary component may be made of a polymer foam or a metal foam. If the foamed secondary component is made of a polymer foam, the polymer foam which is used for producing the component may be composed of any suitable polymer which allows producing a polymer foam having a density of at least 0.25 g/cm³. Preferably, the polymer foam is a polyamide foam, for example a polyamide foam based on polyamide 6, polyamide 6/6.36, polyamide 12, polyamide 610, polyamide 6/66, polyamide 6.12 or a copolyamide.

Preferably, the polyamide is a polyamide as described for example in WO-A 2020/016102 or a copolyamide as described for example in WO-A 2021/052881.

Thus, the polyamide may be for example a polyamide produced by polymerization of
(i) 15 to 84 wt-% of at least one lactam,
(ii) 16 to 85 wt-% of a monomer mixture comprising
   (ii1) at least one C₃₂-C₄₀ dimer acid and
   (ii2) at least one C₄-C₁₂ diamine,
wherein the monomer mixture comprises 45 to 55 mol-% of the component (ii1) and 55 to 45 wt-% of the component (ii2), based on the total amount of the monomer mixture, and the sum of the components (i) and (ii) is 100 wt-%.

If the polyamide is a copolyamide, the polyamide may be for example a polymer mixture comprising
(A) from 5 to 75 wt% of at least one copolyamide prepared by polymerizing
   (A1) from 15 ot 84 wt-% of at least one lactam,
   (A2) from 16 to 85 wt-% of monomer mixture comprising
      (M1) at least one C₃₂-C₄₀ dimer acid and
         (M2) at least one C₄-C₁₂ diamine, where the sum of the components A1 and A2 is 100 wt-%, and
(B) from 25 to 95 wt-% of at least one polyamide which is different from the copolyamide (A).

The polyamide (B) may be selected from the group consisting of polycaprolactam (PA6), polybutylene adipamide (PA4.6), polyhexamethylene adipamide (PA6.6), polyhexamethylene sebacamide (PA6.10), polyhexamethylene dodecanamide (PA6.12), poly-11-aminoundecanamide (PA11), polylaurolactam (PA12), poly-m-xylylene adipamide (PAMXD 6), polypentamethylene sebacamide (PA510), 6T/Z (Z=lactam), 6T/6I/XY, 6T/XT (X=straight-chain or branched C₄-C₁₈-diamine), XT (X=C₄-C₁₈-diamine), PA PACM 12 (PACM=p-diaminodicyclohexylmethane), PA MACM 12 (MACM=3,3-dimethyl-p-diaminodicyclohexylmethane), PA MPMD 6 (MPMD=2-methyl pentamethylene diamine), PA MPMD T, PA MPMD 12, polyhexamethylene isophthalamide (PA 6I), polyhexamethylene isophthalamide cohexamethylene terephthalamide (PA 6I/6T), PA 6-3-T (terephthalic acid polyamide and mixtures of 2,2,4- and 2,4,4-trimethylhex-amethylenediamine), polybutylene sebacamide (PA 4.10), polydecamethylene sebacamide (PA 10.10), polypentamethylene adipamide (PA 5.6), PA 6/66 and PA 66/6, PA 6Y (Y=C₄-C₁₈-di-acid) and their transamidation products.

If a polymer foam is used for producing the foamed secondary component, the polymer of the polymer foam may comprise additives like reinforcing additives, dyes, plasticizers, stabilizers, for example UV-stabilizers and/or flame retardants to achieve the intended density and to set the properties of the polymer foam. If the polymer for the polymer foam comprises reinforcing additives, these may be for example short fibers or pulverulent additives like talcum. If short fibers are used, the fibers may for example carbon fibers, glass fibers, aramid fibers or mineral fibers.

To achieve the intended properties of the component, particularly regarding energy absorption, the foamed secondary component has a density of at least 0.25 g/cm³. Preferably, the foamed secondary component has a density in a range between 0.25 and 0.45 g/cm³ and particularly a density in a range between 0.3 and 0.4 g/cm³.

The foamed secondary component may be made of an open-cell foam or a closed-cell foam. Further, the foamed secondary component also may be made of a combination of an open-cell foam and a closed-cell foam and contain open cells and closed cells. Further, particularly if the foamed secondary component is made of a polymer foam, the foam may be a particle foam or a continuous foam, a particle foam being preferred.

Depending on the intended energy absorption properties, the foamed secondary component may be in contact at least partly with only one side of the sheet profile or may be in contact at least partly with both sides of the sheet profile. If the foamed secondary component is in contact at least partly with both sides of the sheet profile, it is further preferred that the foamed secondary component is in contact with the directly opposite sides of the sheet profile.

For setting the energy absorption properties, it is further possible to use a sheet component with at least two sections with different geometry, for example different cross sectional areas or different shape or with different wall thickness. Particularly if a sheet component is used which has a tubular shape, it is preferred to vary the wall thickness. Besides using one sheet component having at least two sections, it is also possible to use at least two sheet components, each sheet component having a specific geometry. By varying the wall thickness it is for example possible to set the energy absorption properties in such a way that they vary along the component forming a gradient material which is softer at one end and harder at the other end.

The component can be used as a single component or, as an alternative, at least two of the components are connected and form a composite unit. If at least two components are connected to form a composite unit, the sheet profile of each of the components may have the same shape or components with sheet profiles with different shapes may be used. If the sheet profiles have different shapes, at least two of the components may have the same size but differently shaped sheet profiles. Alternatively or additionally, it is also possible that the components have different sizes and the sheet profiles in each of the components have different lengths. In the latter case, the cross sectional geometry of the sheet profiles in the components of different length may be the same.

The at least two components may be connected in parallel and/or in series. In this context, if not defined in a different way for specific embodiments, “in parallel” means that the components are connected in such a way that the longest central axes of the connected components are arranged in parallel, and “in series” means that the longest axes of two connected components are arranged in series.

By connecting at least two components, it is possible to optimize the energy absorption properties of the composite unit by using different shapes of the sheet profiles of the different components.

Particularly if extruded profiles are used as sheet profiles, it is preferred that the extrusion axis is directed into the direction of force. If extrusion profiles with different lengths are used in the components, it is possible to build up a desired force profile during the impact, in which shorter sheet profiles become axially effective later in the crash and contribute to energy absorption.

As an alternative, it is also possible to use sheet profiles having different wall thicknesses. In this case, it is preferred that in the direction of the impact, the impact first acts on components with sheet profiles with lower wall thickness and then on the components having sheet profiles with larger wall thickness.

If components are arranged in parallel and in series, it is further preferred, that the components which are arranged in parallel include sheet profiles with corresponding shapes and the shapes of the sheet profiles of the components being arranged in series differ from that of the previous and following ones in the direction of impact. Here “in parallel” and “in series” relate to the direction of impact.

Besides using components with different shapes of the sheet profile, it is also possible to adapt the properties of the foamed secondary component of the components used for forming the composite unit. In this case, it is for example possible to vary the amount of additives, particularly of reinforcing additives, in the polymer foam of the different components.

For connecting the components to form the composite unit, it is possible to directly connect the components to each other, for example by gluing or welding. Alternatively or additionally, it is also possible to attach the components to a tie member. In this case, the orientation of the tie member preferably is transverse to the direction of an impact.

A process for producing the component preferably comprises:
(a) forming a sheet into the form of the sheet profile;
(b) connecting the sheet profile with the foamed secondary component.

For forming the sheet profile, any process for forming profiles known by the skilled person may be used. If the sheet profile is made of a metal or a thermoplastic polymer, the sheet profile for example may be produced by bending processes, deep drawing processes, pressing processes, or extrusion processes. Also combinations of at least two of these forming processes for forming the sheet profile are possible. If the sheet profile is a hollow profile or a strand profile, extrusion processes are particularly preferred. Hollow profiles or strand profiles for example may be tube profiles or polygonal profiles, e.g. a triangular or a quadrangular profile or a polygon with five or more sides.

Particularly when producing the sheet profile in an extrusion process it is possible to produce a strand profile with any suitable cross-sectional geometry.

After forming the sheet profile, the sheet profile is connected to the foamed secondary component. For this purpose, in one alternative, the foamed secondary component and the sheet profile can be formed in separate processes and subsequently the sheet profile and the foamed secondary component are connected.

For connecting, the foamed secondary component can be attached to the sheet profile by any process known to the skilled person, for example by a form-fit connection, a force-fit connection or a material-fit connection. Suitable connections of the sheet profile and the foamed secondary component for example are screw connections, rivet connection, adhesive bonding or clamping.

Besides the alternatives described above, it is further possible to connect the sheet profile and the foamed secondary component by sliding the sheet profile into the foamed secondary component.

If the sheet component is slid into the foamed secondary component, it is particularly preferred for setting the energy absorption properties to use a sheet component having different wall thicknesses or more than one sheet component, wherein each sheet component has a specific wall thickness adapted to the desired energy absorption properties. However, particularly if the sheet component is slid into the foamed secondary component for production purposes it is preferred to use only one sheet component. In this case, it is particularly preferred, if the shape of the sheet component remains the same and for setting the failure properties only the wall thickness varies.

In a further alternative, the sheet profile is formed and then placed into a mold for producing the foamed secondary component. In this case, after placing the sheet profile in the mold, the starting materials for producing the foamed secondary component are fed into the mold and the foamed secondary component is directly formed and overmolds the sheet profile partially or fully. If the foamed secondary component is made of a continuous foam, it is preferred to feed the reactants from which the foam is formed, including a blowing agent, into the foam and let the foam form in the mold. By this process, the foamed secondary component directly encloses the sheet profile. If the foamed secondary component is made of a particle foam, expanded polymer beads are fed into the mold as starting material and after filling the mold with the expanded polymer beads, the expanded polymer beads are connected and, thus, form the particle foam. For connecting the expanded polymer beads, for example steam is passed through the mold, wherein the steam has a temperature at which the polymer of the expanded polymer beads starts melting so that the expanded polymer beads are welded together and form the particle foam.

Independently of the type of connection of the sheet profile and the foamed secondary component and/or of the components forming the composite unit, the main structure and the secondary structure and/or the components of the composite unit combine and support each other only when under load. In this way, complex nonlinear force curves can also be generated via the targeted coupling of either main components or foamed secondary components or of components of the composite unit over the deformation path.

The component or the composite unit can be used for example in automotive engineering as a bumper or as an A-, B-, or C-pillar as well as in the side rocker area. Further, it is also possible to insert the component or the composite unit into a vehicle component to reinforce the vehicle component. The component and/or the composite unit further may be used in any other application where the energy of a possible impact should be at least partly absorbed.

Embodiments of the invention are shown in the figures and explained in more detail in the following description.

In the figures:

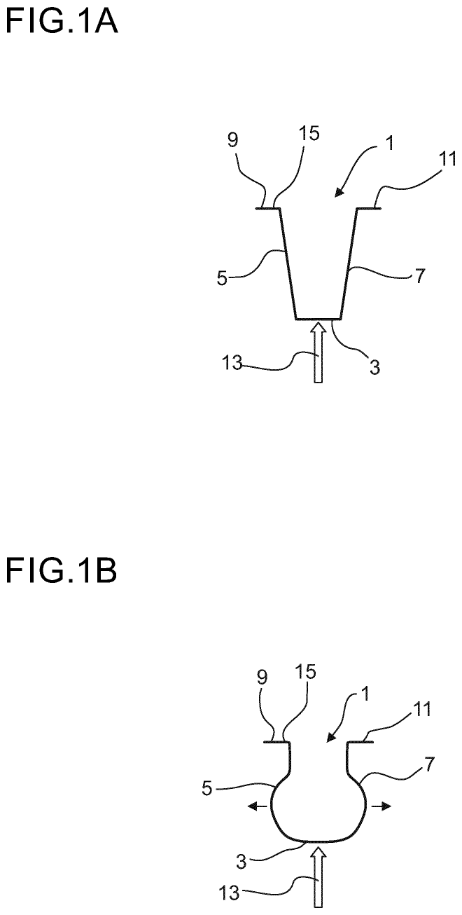

FIG. 1a shows the sheet profile of FIG. 1 in a cross sectional view with a beginning impact,

FIG. 1b shows the sheet profile of FIG. 1 in a deformed state due to an impact,

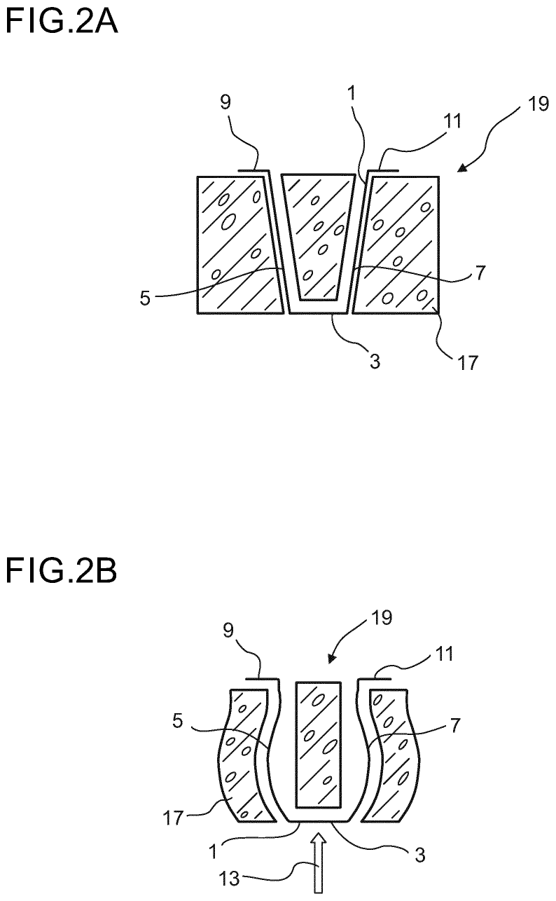

FIG. 2a shows a component with a sheet profile and a foamed secondary component according to the invention,

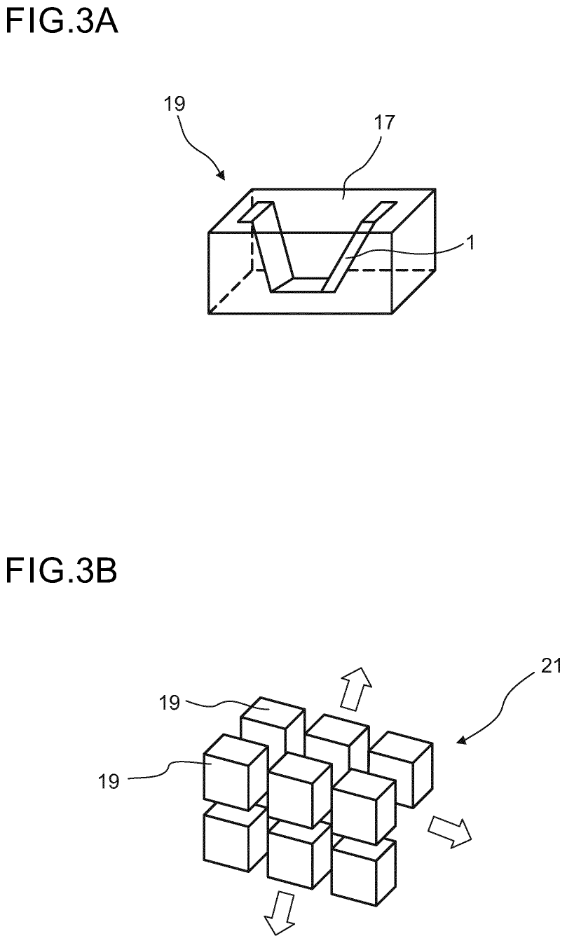

FIG. 2b shows the component of FIG. 3a in a deformed state due to an impact,

FIG. 3a shows a single component,

FIG. 3b shows the principal spatial arrangement of components for forming a composite unit,

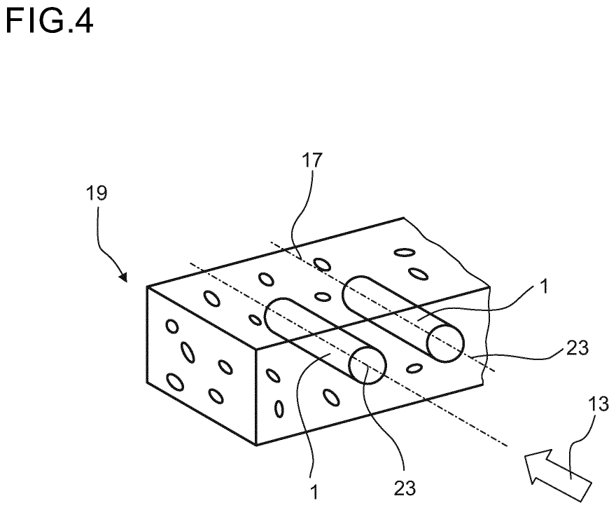

FIG. 4 shows a component with an internal profile embedded in a foamed secondary component.

FIG. 1a shows a cross sectional view of sheet profile, which can be used in a component.

A sheet profile 1 may be formed as shown as an example in FIG. 1, comprising a base 3, a first leg 5 and a second leg 7, the first leg 5 ending in a first edge 9 and the second leg 7 ending in a second edge 11. In the design as shown in FIG. 1a, the first and second edges 9, 11 are oriented parallel to the base 3.

The sheet profile 1 usually will be arranged in such a way that an impact 13 acts on the base 3. The impact 13 being shown by an arrow in FIG. 1a. During the impact 13, the base is moved into the direction of an upper end 15 of the sheet profile 1, the upper end 15 being formed by the first edge 9 and the second edge 11.

Due to the impact 13 and the movement of the base 3, the first leg 5 and the second leg 7 deform. Depending on the material of the sheet profile 1, the first leg 5 and the second leg 7 for example deform as shown in FIG. 1b by buckling. Such a deformation particularly occurs, if the material of the sheet profile deforms elastically or plastically without breaking, for example if the material is a metal like steel. If the material tends to break due to an impact, for example if the sheet material is a thermoset plastic material, particularly a reinforced plastic material with continuous fibers, the legs 5, 7 start to deform as shown in FIG. 1b but soon will break. Depending on the thickness of the sheet profile 1, the deformation already may occur by a weak impact.

Further, particularly if the sheet profile has a comparatively simple design, for example as shown in FIGS. 1a and 1b, the energy which can be absorbed by the sheet component 1 due to deformation of the sheet component 1 is limited.

To increase the amount of energy which can be absorbed, according to the invention, the sheet profile 1 is connected with a foamed secondary component 17, thereby forming a component 19. Such a component is shown in a cross sectional view in FIG. 2a and under load of an impact in FIG. 2b.

The sheet profile 1 may be completely enclosed by the foamed secondary component 17 or, as shown here, only partly enclosed by the foamed secondary component 17. The foamed secondary component 13, which has a density of at least 0.25 g/cm³, supports the deformation of the sheet profile 1 in such a way that the amount of energy which can be absorbed by the controlled deformation of the sheet profile 1 is increased. Further, the foamed secondary component 17 allows for a deformation of the sheet profile 1 in a controlled manner by an impact 13 acting on the sheet profile 1. This support of the deformation of the sheet profile 1 and the deformation in a controlled manner allows for much more energy to be absorbed than the sheet profile 1 alone.

If the sheet profile 1 comprises legs 5, 7 which deform by an impact on the base 1, as shown exemplary in FIGS. 2a, 2b, the foamed secondary component 17 is arranged on the surfaces of the legs. During an impact 13, the foamed secondary component 17 is compressed and, thus, absorbs a part of the energy of the impact and supports the sheet profile 1 such that the sheet profile 1 takes a deformation state more favorable for energy absorption under the load of the impact 13. In this way, by an adopted foamed secondary component 17, the sheet profile 1 is improved in its energy absorbing properties. Further, the maximum load, which shows a start of the failing range can be increased.

For optimizing the energy absorption properties, it is further preferred to combine at least two components 19 to form a composite unit 21. An exemplary component 19 is shown in FIG. 3a and an arrangement of components 19 to form a composite unit 21 is shown in FIG. 3b.

Each component 19 comprises a sheet profile 1 and a foamed secondary component 17. For forming the composite unit 21, the components 19 may be combined in any suitable arrangement.

As shown if FIG. 3b, the components 19 may be arranged for example one upon the other, side by side and/or in series. The arrangement one upon the other and side by side also can be termed as a parallel arrangement. In this context, a parallel arrangement may refer to the orientation of the main axis of the sheet profile or, preferably, on the expected direction of an impact. Correspondingly, an arrangement in series means a combination of the components one after the other in the direction of the main axis of the sheet profile or, preferably, one after the other in the direction of an expected impact on the composite unit 21.

The arrangement of the components 19 may be such that the connecting sides of two adjacent components 19 are in contact over the full surface area of the respective sides. This, however, only is feasible, if all components 19 which are connected to form the composite unit 21 have the same size.

Alternatively, independently of whether all components 19 have the same size or of whether at least some of the components 19 have different sizes, the components also may be connected with an offset.

If all components 19 have the same size as indicated in FIG. 3b, it is possible, to include sheet profiles 1 with different geometries into the components 19 for adapting the energy absorption properties to a specific failure behavior. On the other hand, it is also possible to connect component 19, which all have the same geometry including the same geometry of the sheet profile 1, to form the composite unit 21.

For connecting the components 19 to form the composite unit 21 any suitable joining method known by the skilled person can be used. The components for example can be connected by screws, rivets, gluing, snap connections or attaching the components 19 to a tie member.

Besides the geometry of the sheet profile 1 as shown in the figures, the sheet profile may have any other geometry, depending on the intended use of the component. The geometry of the sheet profile may be determined for example by a simulation calculation. Further, the foamed secondary component 17 may enclose the sheet profile 1 completely or only partially. If the foamed secondary component 17 encloses the sheet profile 1 only partially, the foamed secondary component and a surface of the sheet component may for example form a surface of the component 19 like the component of FIGS. 2a, 2b, where the surface of the base 3 and the foamed secondary component 17 form the bottom side of the component 19 and the surface of the edges 9, 11 and the foamed secondary component 17 form the upper side of the component 19. Besides such an arrangement where a surface of the sheet profile 1 and the foamed secondary component 17 form a surface of the component 19, it is further possible that only a smaller part of the sheet profile 1 is in contact with the foamed secondary component 17. In this case, generally the sheet profile protrudes from the foamed secondary component 17.

If the sheet profile is a hollow profile, it is further possible to arrange the foamed secondary component only on the outer surface of the hollow profile, only to fill the hollow profile with the foamed secondary component or to arrange the foamed secondary component inside the hollow profile and on the outer surface of the hollow profile.

Such a component 19 with a sheet profile 1 having a hollow profile in the shape of a tube and a foamed secondary component 17 enclosing the sheet profile 1 on the outer surface of the hollow profile is shown in FIG. 4.

If the sheet profile 1 is a hollow profile like the tube-shaped hollow profile, the sheet profile 1 is arranged in the foamed secondary component 17 such that the main direction of an impact 13 corresponds to the main axis 23 of the hollow profile. The hollow profile preferably is produced by an extrusion process, and, for this reason, the main axis 23 also corresponds to the extrusion direction.

After producing the hollow profile, the hollow profile is overmolded with the foamed secondary component 17. As an alternative, the hollow profile and the foamed secondary component 17 are produced separately and afterwards the hollow profile is slid into the foamed secondary component 17.

1-15. (canceled)

16. A component for absorbing energy of an impact applied to the component, wherein the component is plastically deformable by an impact and optionally can undergo at least some extent of destruction, the component comprising a sheet profile as a main component and a foamed secondary component, wherein the foamed secondary component is connected to the sheet profile and has a density of more than 0.2 g/cm³.

17. The component according to claim 16, wherein the foamed secondary component is made of a polymer foam.

18. The component according to claim 17, wherein the polymer foam is a polyamide foam.

19. The component according to claim 17, wherein the polymer foam is a particle foam.

20. The component according to claim 16, wherein the polymer foam has a density in a range from 0.25 to 0.45 g/cm³.

21. The component according to claim 16, wherein the polymer foam is at least partly in contact on both sides of the sheet of the sheet profile.

22. The component according to claim 16, wherein the sheet profile is made of a metal or a polymer.

23. The component according to claim 22, wherein the metal is selected from the group consisting of steel, aluminum and aluminum alloys.

24. The component according to claim 23, wherein the polymer the sheet is made of is a polyamide, polybutylene terephthalate, polystyrene or polypropylene.

25. The component according to claim 22, wherein the polymer is reinforced.

26. A composite unit comprising at least two components according to claim 16, the components being connected in parallel and/or in series.

27. The composite unit according to claim 26, further comprising a tie member to which the components are attached.

28. A process for producing a component according to claim 16, the process comprising:
(a) forming a sheet into the form of the sheet profile;
(b) connecting the sheet profile with the foamed secondary component.

29. The process according to claim 28, wherein the foamed secondary component and the sheet profile are formed in separate processes and subsequently the sheet profile and the foamed secondary component are connected.

30. The process according to claim 28, wherein the sheet profile is inserted into a mold and subsequently starting materials for forming the foamed secondary component are fed into the mold.
